(19) United States
(12) Patent Application Publication
(10) Pub. No.: US 2025/0043045 A1
(43) Pub. Date: Feb. 6, 2025

(54) METHOD FOR PREPARING LONG-CHAIN BRANCHED POLYPROPYLENE

(71) Applicant: National Chung Cheng University, Chiayi County (TW)

(72) Inventors: Jing-Cherng Tsai, Chiayi County (TW); Kwang-Ming Chen, Chiayi County (TW); Jung-Hung Kao, Chiayi County (TW); Kun-Pei Hsieh, Chiayi County (TW); Chao-Shun Chang, Chiayi County (TW); Hsing-Chun Chen, Chiayi County (TW); Chun-Wei Chiu, Chiayi County (TW); Cheng-Hung Chiang, Chiayi County (TW); Yu-Chuan Sung, Chiayi County (TW); Shang-Lin Tsai, Chiayi County (TW); Yu-Sheng Lin, Chiayi County (TW)

(21) Appl. No.: 18/789,571

(22) Filed: Jul. 30, 2024

(30) Foreign Application Priority Data
Aug. 1, 2023 (TW) 112128826

(51) Int. Cl. C08F 110/06

(52) U.S. Cl. CPC C08F 110/06; C08F 2410/01; C08F 2420/10

(57) ABSTRACT

A method for preparing a long-chain branched polypropylene includes subjecting a T-reagent to a polymerization reaction with propylene in the presence of a catalyst composition. The catalyst composition includes an alkylaluminoxane and a metallocene-based catalyst. The metallocene-based catalyst contains a metal selected from the group consisting of titanium (Ti), zirconium (Zr), and hafnium (Hf). The T-reagent having an alkenyl silyl functional group is selected from the group consisting of 1,2-bis[dimethyl(vinyl)silyl]ethane, dimethyldivinylsilane, 7-octenyldimethyl(vinyl)silane, 7-octenyldimethyl(allyl)silane, 4-(but-3-enyl)phenyldimethyl(vinyl)silane, 4-(but-3-enyl)phenyldimethyl(allyl)silane, and combinations thereof.

### CROSS-REFERENCE TO RELATED APPLICATION

This application claims priority to Taiwanese Invention Patent Application No. 112128826, filed on Aug. 1, 2023, which is incorporated by reference herein in its entirety.

### FIELD

The disclosure relates to a method for preparing a polyolefin, and more particularly to a method for preparing a long-chain branched polypropylene.

### BACKGROUND

Polypropylene is a material with chemical and heat resistance, and thus is widely applied in industries, such as packaging materials and textiles. However, polypropylene has a low melt strength under a molten state, and some issues may arise during the processing of polypropylene. For example, edge wrinkling may occur when polypropylene is extruded at high speed during the film-coating process; fluid-flow rates may be unstable during the co-extrusion process when polypropylene is used to make a laminated structure or foam collapse may occur during the foaming process in the manufacture of foamed polypropylene. Consequently, due to its low melt strength problem, polypropylene may have limited applications.

To overcome the abovementioned issues, previous studies have attempted to introduce branched groups into polypropylene to enhance the melt strength of PP polymer. For instance, Chinese Invention Patent Application Publication No. 101035813 A discloses a one-pot polymerization method for preparing a long-chain branched polypropylene, which includes subjecting a T-reagent (a connecting structure to connect polypropylene chain for forming long-chain branched PP) to a polymerization reaction with polypropylene in the presence of a transition metal coordination catalyst (e.g., a metallocene catalyst). The T-reagent in the prior patent may be selected from the group consisting of p-(3-butenyl)styrene/hydrogen, p-(ethylnorborenyl)styrene/hydrogen, 5-hexenylalkylboron hydride, ethylnorborenylalkylboron hydride, 5-hexenyldialkylsilicon hydride, ethylnorborenyldialkylsilicon hydride, and combinations thereof. Due to low catalyst activity for incorporation of a styrenic moiety onto the polypropylene backbone, these types of T-reagent typically provide polypropylene with an extremely low long-chain branched polypropylene content. Furthermore, the synthesis of long-chain branched polypropylene is also disclosed in another Chinese Invention Patent (Application Publication No. 116199813 A), which described the utilization of alkenyl silyl dichloride as the linking reagent for the synthesis of long-chain branched polypropylene. It should be noted that this synthetic procedure involved a two-step synthetic procedure for the generation of long-chain branched polypropylene. Namely, the synthesis involves copolymerization of alkenyl silyl chloride to give functionalized polypropylene containing silyl chloride functional group by metallocene catalyst in the first step. After that, long-chain branched polypropylene was generated by hydroxylation of the silyl chloride functional group of the functionalized polypropylene prepared in the first step that led to the generation of siloxy group containing long-chain branched polypropylene. We have to point out that this hydroxylation process could be troublesome for the industrial process as the silyl chloride functional group is very reactive toward H₂O. In fact, the exothermic hydroxylation reaction generates hazardous hydrogen chloride, which is not only environmentally harmful but also easily corrodes the stainless-steel reactor. As a result, we believe that a simple and less hazardous process can be very important for the industrial production of long-chain branched polypropylene.

Despite the aforementioned, there is still a need for enhancing the incorporation ratio of T-reagent (e.g., by increasing the concentration of T-reagent in the polymerization solution) to ensure the generation of high concentration of long-chain branched PP. Of note, prior methods for syntheses of long-chain branched PP typically have the difficulty of successfully incorporating of high concentration of T-reagent as the prior methods involve using low reactivity T-reagents such as boron hydride and silicon hydride species.

### SUMMARY

Therefore, the object of the disclosure is to provide a method for preparing a long-chain branched polypropylene, which can alleviate the drawbacks of the prior art. The method includes:
subjecting a T-reagent to a polymerization reaction with propylene in the presence of a catalyst composition.

The catalyst composition includes an alkylaluminoxane and a metallocene-based catalyst. The metallocene-based catalyst contains a metal selected from the group consisting of titanium (Ti), zirconium (Zr), and hafnium (Hf), and the T-reagent having an alkenyl silyl functional group is selected from the group consisting of 1,2-bis[dimethyl(vinyl)silyl]ethane, dimethyldivinylsilane, 7-octenyldimethyl(vinyl)silane, 7-octenyldimethyl(allyl)silane, 4-(but-3-enyl)phenyldimethyl(vinyl)silane, 4-(but-3-enyl)phenyldimethyl(allyl)silane, and

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 shows a ¹H-NMR spectrum (in CDCl₃) of Synthetic Example 2-1.

FIG. 2 shows a ¹H-NMR spectrum (in CDCl₃) of Synthetic Example 2-2.

FIG. 3 shows a ¹H-NMR spectrum (in C₃D₆O) of Synthetic Example 2-3.

FIG. 4 shows a ¹H-NMR spectrum (in C₃D₆O) of Synthetic Example 2-4.

FIG. 5 shows a ¹H-NMR spectrum (in C₂D₂Cl₄) of Example I-a.

FIG. 6 shows a ¹H-NMR spectrum (in C₂D₂Cl₄) of Example I-b.

FIG. 7 shows a ¹H-NMR spectrum (in C₂D₂Cl₄) of Example I-c.

FIG. 8 shows a ¹H-NMR spectrum (in C₂D₂Cl₄) of Example II-a.

FIG. 9 shows a ¹H-NMR spectrum (in C₂D₂Cl₄) of Example II-b.

FIG. 10 shows a ¹H-NMR spectrum (in C₂D₂Cl₄) of Example II-c.

FIG. 11 shows a ¹H-NMR spectrum (in C₂D₂Cl₄) of Example II-d.

FIG. 12 shows a Lissajous-Bowditch curve of Example I-a.

FIG. 13 shows a Lissajous-Bowditch curve of Example I-b.

FIG. 14 shows a Lissajous-Bowditch curve of Example I-c.

FIG. 15 shows a Lissajous-Bowditch curve of Example II-a.

FIG. 16 shows a Lissajous-Bowditch curve of Example II-b.

FIG. 17 shows a Lissajous-Bowditch curve of Example II-c.

FIG. 18 shows a Lissajous-Bowditch curve of Example II-d.

FIG. 19 shows a Lissajous-Bowditch curve of Example II-e.

### DETAILED DESCRIPTION

Before the present disclosure is described in greater detail, it should be noted that if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a method for preparing a long-chain branched polypropylene, which includes:
subjecting a T-reagent to a polymerization reaction with propylene in the presence of a catalyst composition.

The catalyst composition includes an alkylaluminoxane and a metallocene-based catalyst. The metallocene-based catalyst contains a metal selected from the group consisting of titanium (Ti), zirconium (Zr), and hafnium (Hf), and the T-reagent having an alkenyl silyl functional group is selected from the group consisting of 1,2-bis[dimethyl(vinyl)silyl]ethane, dimethyldivinylsilane, 7-octenyldimethyl(vinyl)silane, 7-octenyldimethyl(allyl)silane, 4-(but-3-enyl)phenyldimethyl(vinyl)silane, 4-(but-3-enyl)phenyldimethyl(allyl)silane, and combinations thereof.

### <Catalyst>

An example of the alkylaluminoxane in the catalyst composition may include but is not limited to, methylaluminoxane. In certain embodiments, the alkylaluminoxane may be methylaluminoxane.

The metallocene-based catalyst contains the metal selected from Group 4B in the periodic table as mentioned above, i.e., Ti, Zr, and Hf. In certain embodiments, the metallocene-based catalyst may have a bent sandwich structure. In other embodiments, the metallocene-based catalyst may be an ansa-metallocene compound. Examples of the ansa-metallocene compound may include but are not limited to, dimethylsilylene-bis-(2-methyl-4-phenylindenyl)zirconium dichloride (Me₂Si(2-Me-4-Ph-1-Ind)₂ZrCl₂), and dimethylsilylene(bis-indenyl)zirconium dichloride (Me₂Si(Ind)₂ZrCl_{2\}). In certain embodiments, the metallocene-based catalyst may be selected from the group consisting of a titanium metallocene-based catalyst, a zirconium metallocene-based catalyst, and a hafnium metallocene-based catalyst. In certain embodiments, the zirconium metallocene-based catalyst may be selected from the group consisting of bis-(n-butylcyclopentadienyl)zirconium dichloride ((ⁿBuCp)₂ZrCl₂), bis(n-propylcyclopentadienyl)zirconium dichloride, bis(ethylcyclopentadienyl)zirconium dichloride, bis(methylcyclopentadienyl)zirconium dichloride, bis(1,3-dimethylcyclopentadienyl)zirconium dichloride, bis(1-butyl-3-methylcyclopentadienyl)zirconium dichloride, ethylenebis(indenyl)zirconium dichloride (C₂H₄(Ind)₂ZrCl₂), dimethylsilylbis(2-methylindenyl)zirconium dichloride, dimethylsilylene-bis-(2-methyl-4-phenylindenyl)zirconium dichloride, and dimethylsilylene(bis-indenyl)zirconium dichloride. In certain embodiments, the hafnium metallocene-based catalyst may be selected from the group consisting of bis(cyclopentadienyl) hafnium dichloride, bis(ethylcyclopentadienyl) hafnium dichloride, and bis(isopropylcyclopentadienyl) hafnium dichloride. In certain embodiments, the zirconium metallocene-based catalyst may be dimethylsilylene-bis-(2-methyl-4-phenylindenyl)zirconium dichloride or dimethylsilylene(bis-indenyl)zirconium dichloride.

In certain embodiments, the catalyst composition may further include silica particles, and the alkylaluminoxane and the metallocene-based catalyst may be anchored and supported onto silica particles.

### <T-Reagent>

In certain embodiments, the T-reagent having the alkenyl silyl functional group may be selected from the group consisting of 7-octenyldimethyl(vinyl)silane, 7-octenyldimethyl(allyl)silane, 4-(but-3-enyl)phenyldimethyl(vinyl)silane, and 4-(but-3-enyl)phenyldimethyl(allyl)silane.

In certain embodiments, the T-reagent may be present in an amount ranging from 1 millimole to 2.5 millimoles.

In certain embodiments, the zirconium metallocene-based catalyst may be dimethylsilylene-bis-(2-methyl-4-phenylindenyl)zirconium dichloride, and the T-reagent may be selected from the group consisting of 7-octenyldimethyl(vinyl)silane, 7-octenyldimethyl(allyl)silane, 4-(but-3-enyl)phenyldimethyl(vinyl)silane, and 4-(but-3-enyl)phenyldimethyl(allyl)silane.

In certain embodiments, the zirconium metallocene-based catalyst may be dimethylsilylene(bis-indenyl)zirconium dichloride, and the T-reagent may be 4-(but-3-enyl)phenyldimethyl(allyl)silane.

In certain embodiments, the propylene may have a partial pressure ranging from 4 bar to 10 bar. Examples of the polymerization reaction may include, but are not limited to, a solution polymerization reaction, a slurry polymerization reaction, and a gas-phase polymerization reaction. In certain embodiments, the polymerization reaction may be the slurry polymerization reaction which is carried out in the presence of the catalyst and a diluent solvent, and the catalyst may include the silica particles supported the metallocene-based catalyst. Examples of diluent solvent may include but are not limited to, isopar E, pentane, hexane and heptane. In certain embodiments, the polymerization reaction may be the solution polymerization reaction which is carried out at a temperature ranging from 40° C. to 80° C. In certain embodiments, the polymerization reaction may be the slurry polymerization reaction which is carried out at a temperature ranging from 65° C. to 75° C., and a pressure ranging from 1 kg/cm² to 10 kg/cm².

In some embodiments, the long-chain branched polypropylene may be polypropylene or block graft copolymer.

The disclosure will be further described by way of the following examples. However, it should be understood that the following examples are solely intended for the purpose of illustration and should not be construed as limiting the disclosure in practice.

### Synthetic Example 1-1: Supported Catalyst 1

First, 3 g of the silica particles (molecular weight is 60.085 g/mol) was calcined at 150° C. for 3 hours and then mixed with 6 g of methylaluminoxane suspended solution mixture, followed by adding 75 ml of anhydrous toluene (serving as a solvent) to obtain a mixture. Afterward, the mixture was heated to 110° C., and then stirred at 110° C. for 6 hours, followed by cooling down to room temperature. Next, the cooled solution was mixed with n-hexane and then left standing for 1 day, followed by filtration to obtain a filter cake. Thereafter, the filter cake was repeatedly washed with toluene and n-pentane for three cycles, followed by drying to obtain a crude product in the form of a white solid. The methylaluminoxane was present in an amount of 18.4 wt % based on 100 wt % of the crude product.

After that, the crude product was charged with 5 mL of toluene and 0.31441 mg of dimethylsilylene-bis-(2-methyl-4-phenylindenyl)zirconium dichloride. The resulting solution was allowed to stir for 0.5 hours to obtain a reactive catalyst mixture.

### Synthetic Example 1-2: Supported Catalyst 2

First, 3 g of the silica particles (molecular weight is 60.085 g/mol) was calcined at 150° C. for 3 hours and then mixed with 6 g of methylaluminoxane suspended solution mixture, followed by adding 75 ml of anhydrous toluene (serving as a solvent) to obtain a mixture. Afterward, the mixture was heated to 110° C., and then stirred at 110° C. for 6 hours, followed by cooling down to room temperature. Next, the cooled solution was mixed with n-hexane and then left standing for 1 day, followed by filtration to obtain a filter cake. Thereafter, the filter cake was repeatedly washed with toluene and n-pentane for three cycles, followed by drying to obtain a crude product in the form of a white solid. The methylaluminoxane was present in an amount of 18.4 wt % based on 100 wt % of the crude product.

After that, the crude product was charged with 5 mL of toluene and 0.224265 mg of dimethylsilylene(bis-indenyl)zirconium dichloride. The resulting solution was allowed to stir for 0.5 hours to obtain a reactive catalyst mixture.

### Synthetic Example 2-1:7-octenyldimethyl(vinyl)silane

In a 500 mL round bottle flask was charged with 150 ml of tetrahydrofuran and 8 g of 7-octenyldimethylchlorosilane. The solution was allowed to cool and maintained at −20° C. with stirring. Then, the solution was charged with 50 ml of vinyl magnesium bromide (1.0 M solution in tetrahydrofuran). The reaction solution was slowly warmed to room temperature and was allowed to stir at room temperature for 24 hours. After that, the reaction solution was quenched with 50 mL of deionized water to terminate the reaction. The organic layer of the solution was extracted with diethyl ether (50 mL; 3 times). The collected organic layer was dried by magnesium sulfate to provide a light yellow solution. The solution was allowed to remove volatile under vacuum to give 4.5 g of 7-octenyldimethyl(vinyl)silane as the pale yellow liquid.

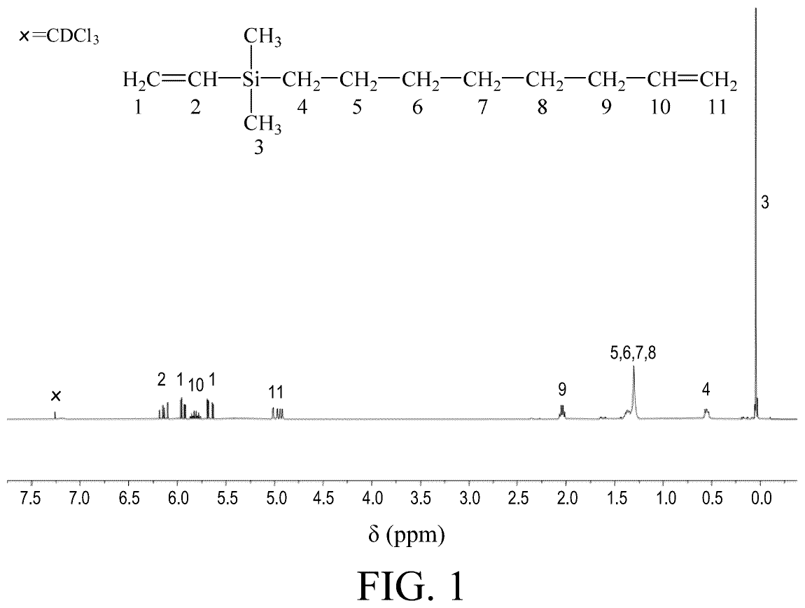

Afterward, the pale yellow liquid was analyzed to determine the chemical structures thereof using a nuclear magnetic resonance spectrometer (BRUKER; Model: AVANCE III HD 600 Spectrometer). The results are shown in FIG. 1.

### Synthetic Example 2-2:7-octenyldimethyl(allyl)silane

In a 500 mL round bottle flask was charged with 150 ml of tetrahydrofuran and 8 g of 7-octenyldimethylchlorosilane. The solution was allowed to cool and maintained at −20° C. with stirring. Then, the solution was charged with 50 ml of allyl magnesium bromide (1.0 M solution in diethyl ether). The reaction solution was slowly warmed to room temperature and was allowed to stir at room temperature for 24 hours. After that, the reaction solution was quenched with 50 mL of deionized water to terminate the reaction. The organic layer of the solution was extracted with diethyl ether (50 ml; 3 times). The collected organic layer was dried by magnesium sulfate to provide a light yellow solution. The solution was allowed to remove volatile under vacuum to give 4.5 g of 7-octenyldimethyl(allyl)silane as the pale yellow liquid.

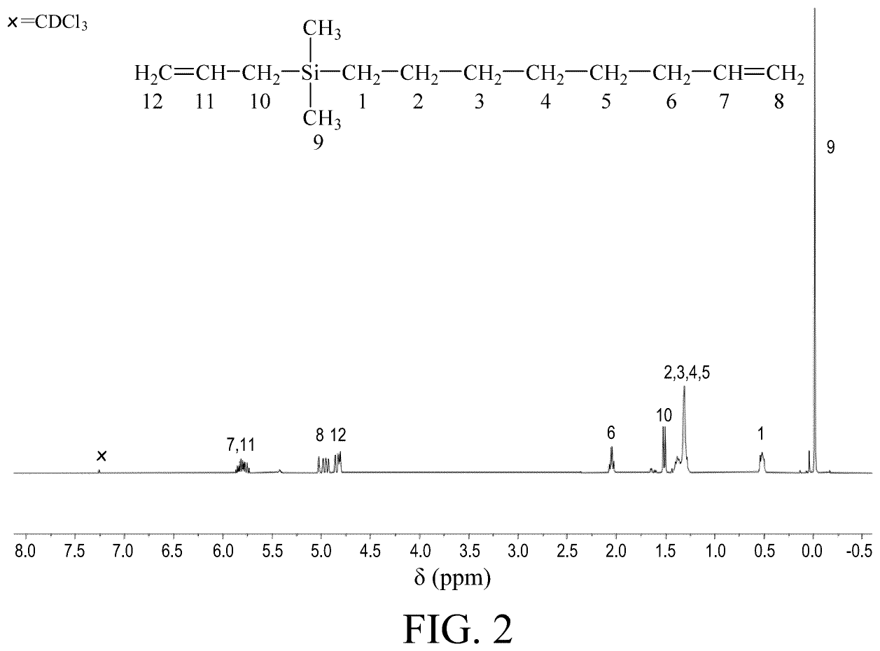

Afterward, the pale yellow liquid was analyzed to determine the chemical structures thereof using the nuclear magnetic resonance spectrometer. The results are shown in FIG. 2.

### Synthetic Example 2-3: 4-(but-3-enyl)phenyldimethyl(vinyl)silane

In a 500 mL round bottle flask was charged with 100 ml of tetrahydrofuran and 11.6 g of 4-bromobenzyl bromide. The solution was allowed to cool and maintained at 0° C. with stirring. Then, the solution was charged with 50 mL of allyl magnesium bromide (1.0 M solution in diethyl ether) and was allowed to stir for 6 hours. After that, the reaction solution was quenched with 50 ml of deionized water to terminate the reaction. The organic layer of the solution was extracted with n-hexane (50 mL; 3 times) to provide a light yellow solution. The solution was allowed to remove volatile under vacuum to obtain pre-product. After that, in a 500 mL round bottle flask was charged with 150 mL of tetrahydrofuran and pre-product. The solution was allowed to cool and maintained at −78° C. with stirring. Then, the solution was charged with 30 ml of n-butyllithium. (1.6 M solution in n-hexane) and was allowed to stir at −78° C. for 1 hour. Next, the solution was charged with 6 g of chlorodimethyl(vinyl)silane and was allowed to stir at −78° C. for 24 hours. After that, the reaction solution was quenched with a small amount of deionized water to terminate the reaction. The organic layer of the solution was extracted with n-hexane (50 mL; 3 times) to provide a light yellow solution. The solution was allowed to remove volatile under vacuum to give 4 g of 4-(but-3-enyl)phenyldimethyl(vinyl)silane as the pale yellow liquid.

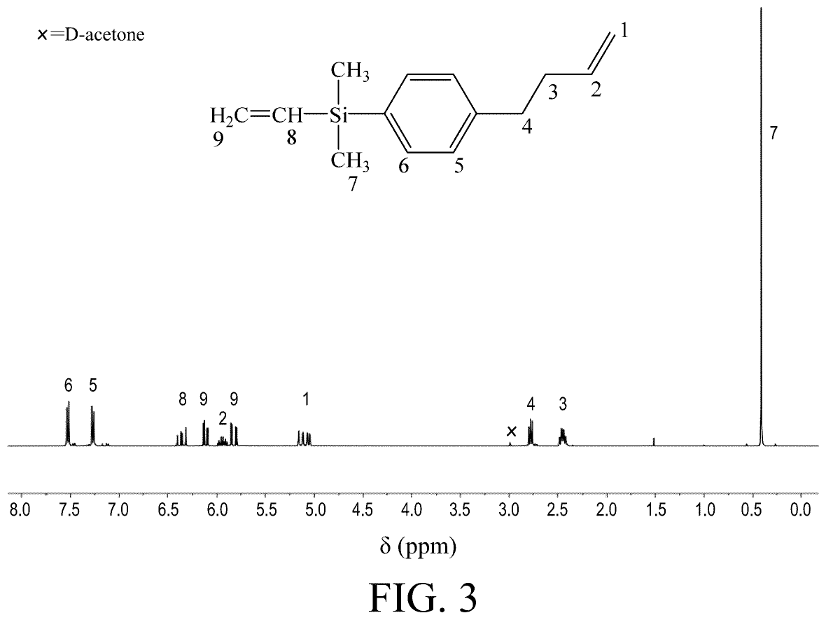

Afterward, the pale yellow liquid was analyzed to determine the chemical structures thereof using the nuclear magnetic resonance spectrometer. The results are shown in FIG. 3.

### Synthetic Example 2-4: 4-(but-3-enyl)phenyldimethyl(allyl)silane

In a 500 mL round bottle flask was charged with 100 ml of tetrahydrofuran and 11.6 g of 4-bromobenzyl bromide. The solution was allowed to cool and maintained at 0° C. with stirring. Then, the solution was charged with 50 mL of allyl magnesium bromide (1.0 M solution in diethyl ether) and was allowed to stir for 6 hours. After that, the reaction solution was quenched with 50 ml of deionized water to terminate the reaction. The organic layer of the solution was extracted with n-hexane (50 mL; 3 times) to provide a light yellow solution. The solution was allowed to remove volatile under vacuum to obtain pre-product. After that, in a 500 mL round bottle flask was charged with 150 ml of tetrahydrofuran and pre-product. The solution was allowed to cool and maintained at −78° C. with stirring. Then, the solution was charged with 30 ml of n-butyllithium. (1.6 M solution in n-hexane) and was allowed to stir at −78° C. for 1 hour. Next, the solution was charged with 6 g of chlorodimethyl(allyl)silane and was allowed to stir at −78° C. for 24 hours. After that, the reaction solution was quenched with a small amount of deionized water to terminate the reaction. The organic layer of the solution was extracted with n-hexane (50 mL; 3 times) to provide a light yellow solution. The solution was allowed to remove volatile under vacuum to give 4 g of 4-(but-3-enyl)phenyldimethyl(allyl)silane as the pale yellow liquid.

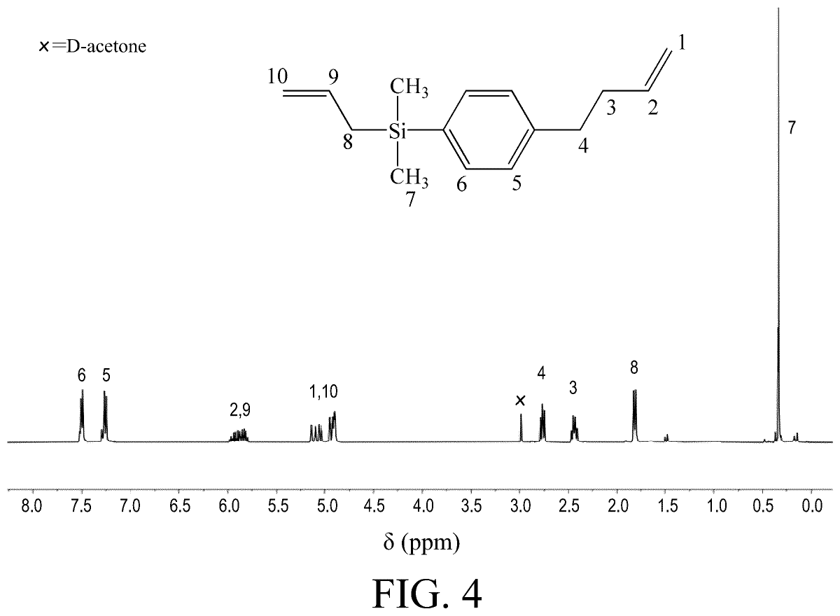

Afterward, the pale yellow liquid was analyzed to determine the chemical structures thereof using the nuclear magnetic resonance spectrometer. The results are shown in FIG. 4.

### Preparation of Long-Chain Branched Polypropylene

### Example I-a

A high pressure reactor equipped with a magnet stirring bar was vacuum-dried and was then filled with nitrogen gas, followed by adding sequentially with 100 mL of toluene, 4 millimoles of methylaluminoxane (serving as a catalyst), and 1 millimole of the 7-octenyldimethyl(allyl)silane (obtained in Synthetic Example 2-2). After that, the reactor was heated to 70° C. and was then added with 5 mL of toluene solution (contain 1×10⁻³ M of dimethylsilylene-bis-(2-methyl-4-phenylindenyl)zirconium dichloride). After that, the reactor was charged with 6 bar of propylene to initiate the homogeneous polymerization solution reaction. The reaction was allowed to maintain at 70° C. for 60 minutes. After that, the reactor was charged with 1 mL of methanol to terminate the polymerization reaction. The polymer solution was decanted into a beaker. Polypropylene generated via the solution polymerization was precipitated after charged with 50 ml of ethanol. The resulting PP polymer was isolated by filtration and dried at 60° C. under vacuum to give 17.10 g of long-chain branched propylene (Example I-a).

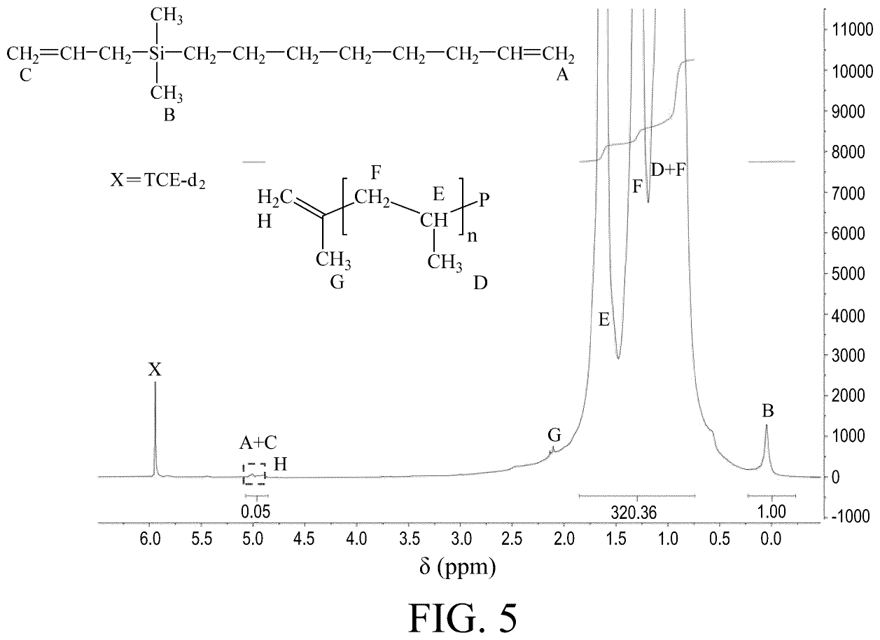

The long-chain branched polypropylene of Example I-a was structural analyzed by using nuclear magnetic resonance spectrometer. The results are shown in FIG. 5.

### Example I-b

The solution polymerization procedures for preparing the long-chain branched polypropylene of Example I-b were similar to those of Example I-a, except that the 7-octenyldimethyl(allyl)silane of Synthetic Example 2-2 used in Example I-a was replaced with the 7-octenyldimethyl(vinyl)silane obtained in Synthetic Example 2-1, thereby obtaining 23.77 g of long-chain branched polypropylene (Example I-b).

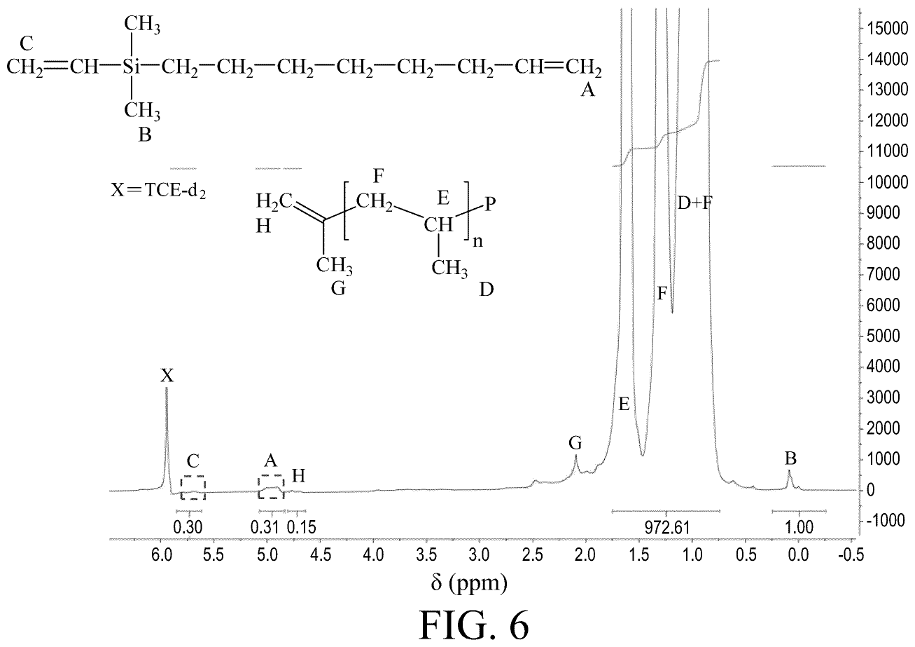

The long-chain branched polypropylene of Example I-b was structural analyzed by using nuclear magnetic resonance spectrometer. The results are shown in FIG. 6.

### Example I-c

The solution polymerization procedures for preparing the long-chain branched polypropylene of Example I-c were similar to those of Example I-a, except that the 7-octenyldimethyl(allyl)silane of Synthetic Example 2-2 used in Example I-a was replaced with 2.5 millimoles of the 4-(but-3-enyl)phenyldimethyl(allyl)silane obtained in Synthetic Example 2-4, thereby obtaining 18.19 g of long-chain branched polypropylene (Example I-c).

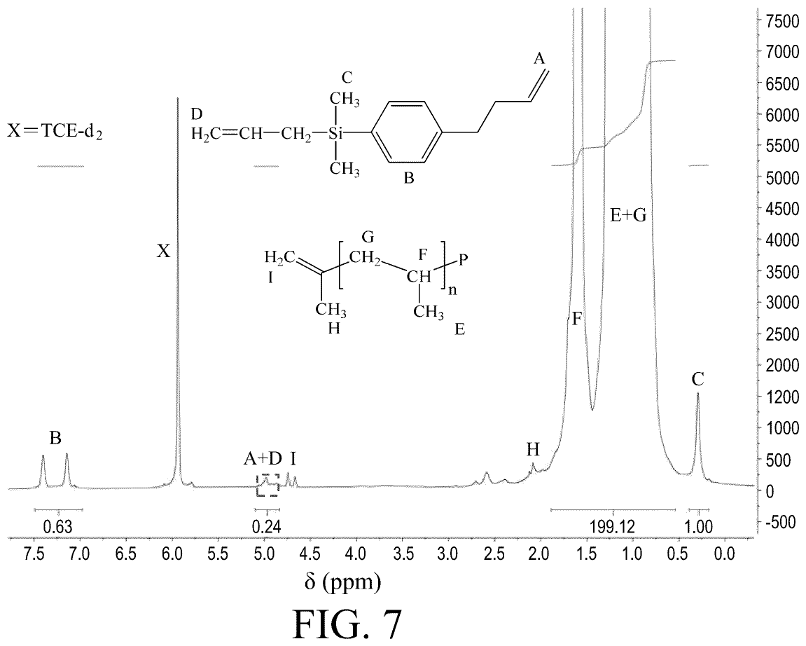

The long-chain branched polypropylene of Example I-c was structural analyzed by using nuclear magnetic resonance spectrometer. The results are shown in FIG. 7.

### Example II-a

A high pressure reactor equipped with a magnet stirring bar was vacuum-dried and was then filled with nitrogen gas, followed by adding sequentially with 250 ml of heptane, 0.6 millimoles of triisobutylaluminum and 1 millimole of the 7-octenyldimethyl(allyl)silane obtained in Synthetic Example 2-2. After that, the reactor was heated to 70° C. and was then charged with 5 mL catalyst solution (contain 40 mg of the catalyst particles obtained in Synthetic Example 1-1 (serving as a catalyst) and toluene), followed by charging with 10 bar of propylene to initiate the slurry polymerization reaction at 70° C. for 60 minutes. After that, the reactor was charged with 10 ml of methanol to terminate the slurry polymerization. The polymer solution was decanted into a beaker. Polypropylene generated via the slurry polymerization was precipitated after charged with 50 ml of ethanol. The resulting PP polymer was isolated by filtration and dried at 60° C. under vacuum to give 44.05 g of long-chain branched propylene (Example II-a).

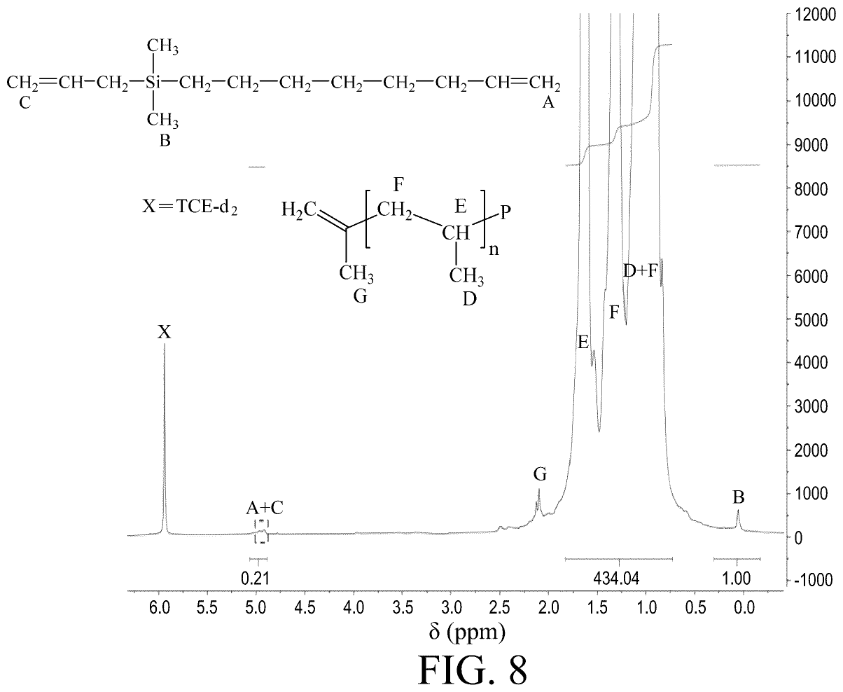

The long-chain branched polypropylene of Example II-a was structural analyzed by using nuclear magnetic resonance spectrometer. The results are shown in FIG. 8.

### Example II-b

The slurry polymerization procedures for preparing the long-chain branched polypropylene of Example II-b were similar to those of Example II-a, except that the 7-octenyldimethyl(allyl)silane of Synthetic Example 2-2 used in Example II-a was replaced with the 7-octenyldimethyl(vinyl)silane obtained in Synthetic Example 2-1, thereby obtaining 16.15 g of long-chain branched polypropylene (Example II-b).

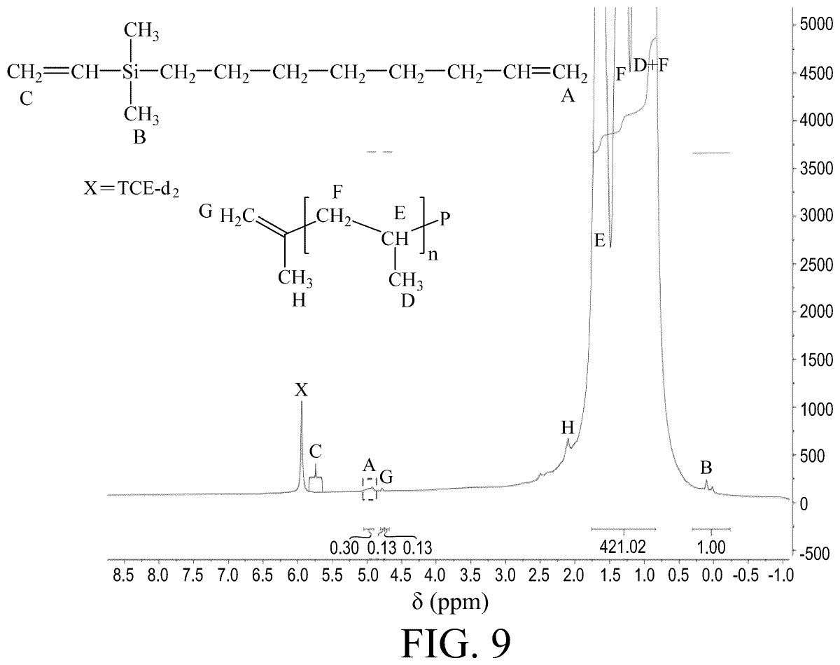

The long-chain branched polypropylene of Example II-b was structural analyzed by using nuclear magnetic resonance spectrometer. The results are shown in FIG. 9.

### Example II-c

The slurry polymerization procedures for preparing the long-chain branched polypropylene of Example II-c were similar to those of Example II-a, except that the 7-octenyldimethyl(allyl)silane of Synthetic Example 2-2 used in Example II-a was replaced with 2.5 millimoles of the 4-(but-3-enyl)phenyldimethyl(allyl)silane obtained in Synthetic Example 2-4, thereby obtaining 37.89 g of long-chain branched polypropylene (Example II-c).

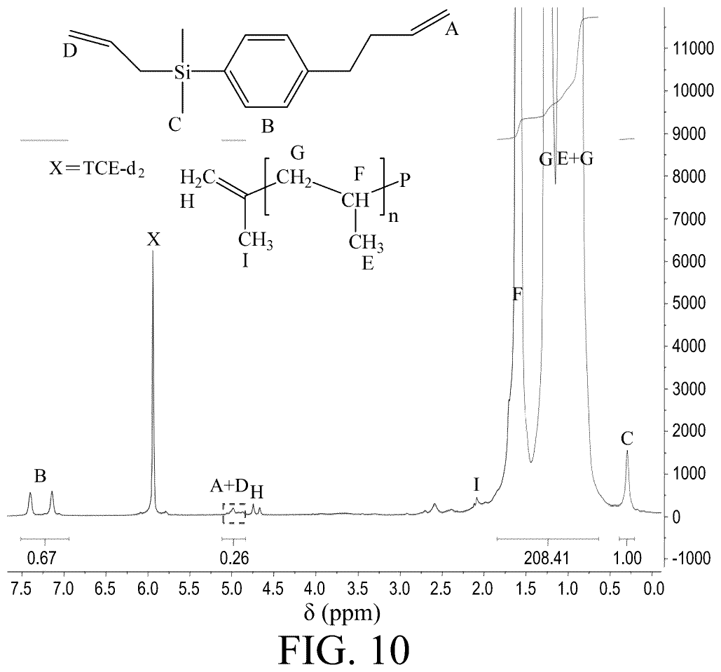

The long-chain branched polypropylene of Example II-c was structural analyzed by using nuclear magnetic resonance spectrometer. The results are shown in FIG. 10.

### Example II-d

The slurry polymerization procedures for preparing the long-chain branched polypropylene of Example II-d were similar to those of Example II-a, except that the 7-octenyldimethyl(allyl)silane of Synthetic Example 2-2 used in Example II-a was replaced with 2.5 millimoles of the 4-(but-3-enyl)phenyldimethyl(vinyl)silane obtained in Synthetic Example 2-3, thereby obtaining 11.88 g of long-chain branched polypropylene (Example II-d).

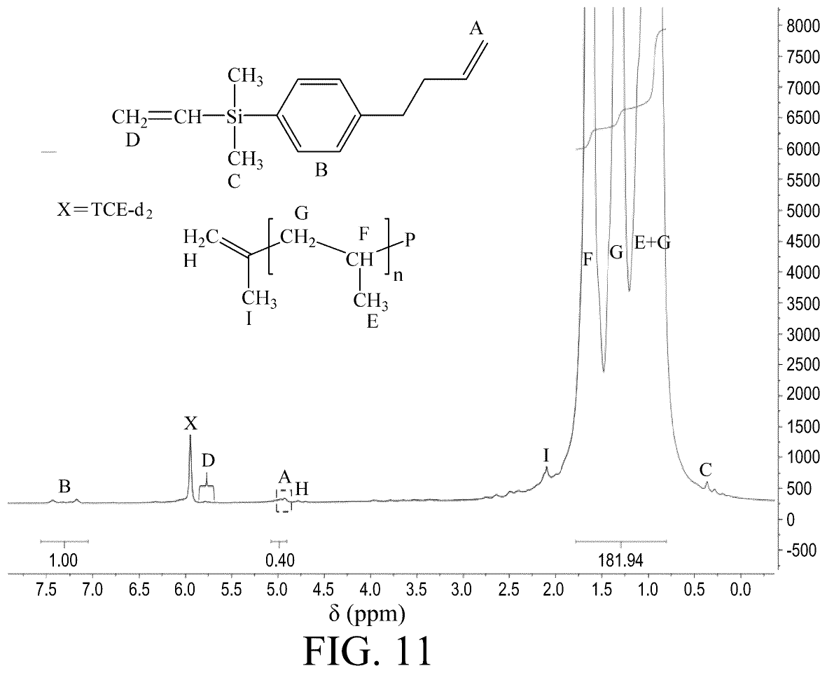

The long-chain branched polypropylene of Example II-d was structural analyzed by using nuclear magnetic resonance spectrometer. The results are shown in FIG. 11.

### Example II-e

The slurry polymerization procedures for preparing the long-chain branched polypropylene of Example II-e were similar to those of Example II-c, except that the supported catalyst 1 of Synthetic Example 1-1 used in Example II-c was replaced with the supported catalyst 2 of Synthetic Example 1-2, and 1.5 millimoles of the 4-(but-3-enyl)phenyldimethyl(allyl)silane obtained in Synthetic Example 2-4 was used, thereby obtaining 2.62 g of long-chain branched polypropylene (Example II-e).

### Property Evaluation

### 1. Determination of Long-Chain Branched Polypropylene

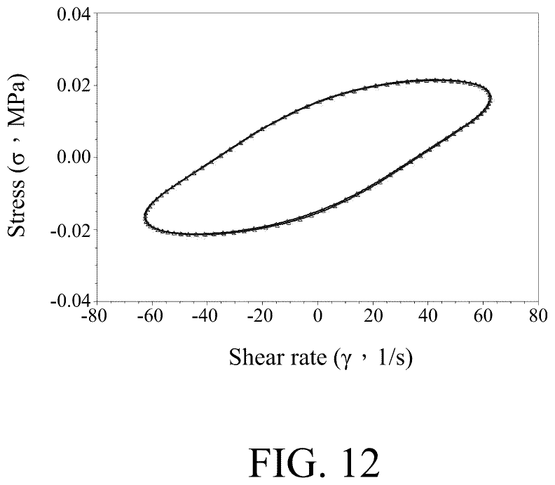

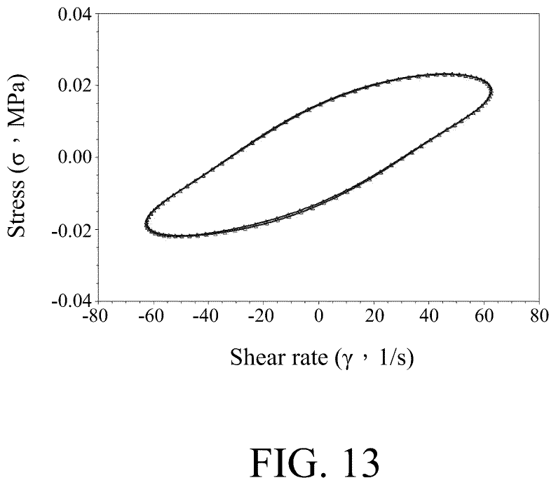

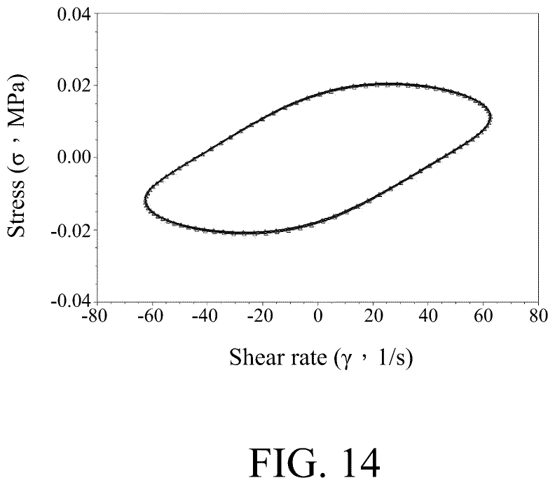

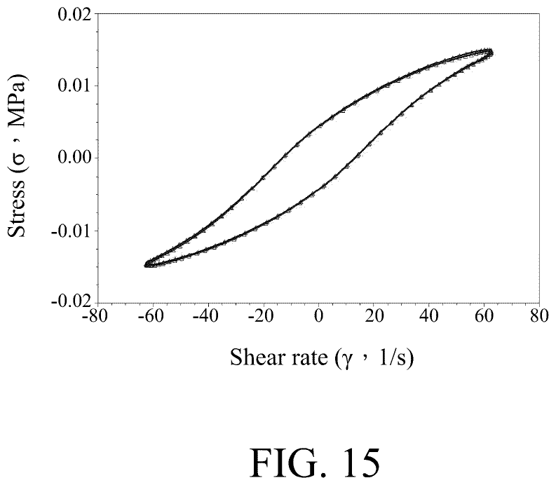

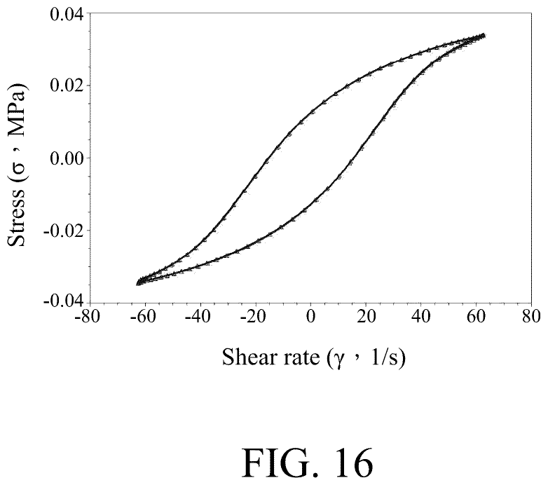

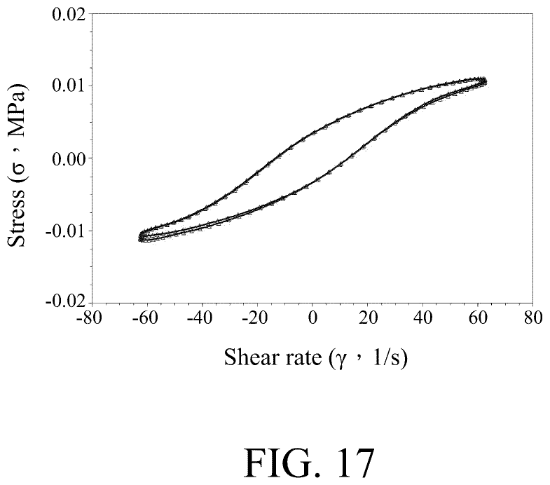

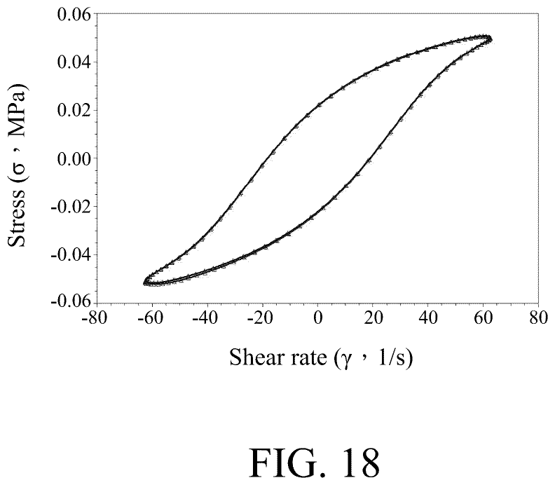

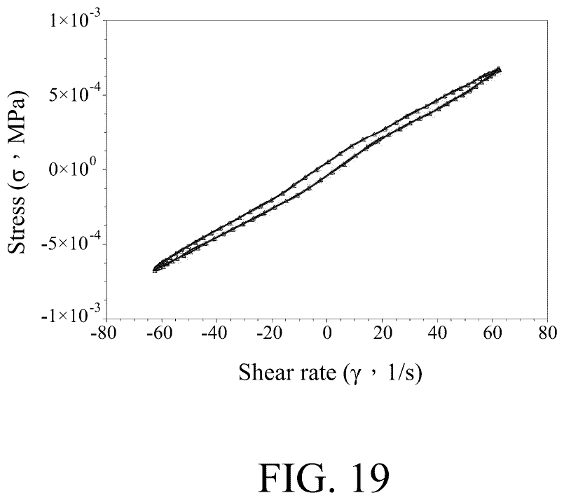

The long-chain branched polypropylene of each of Examples I-a, I-b, I-c, II-a, II-b, II-c, II-d and II-e was analyzed using a large amplitude oscillatory shear (LAOS) produced by TA Instruments (Model: ARES G2). It should be noted that the characterization of long-chain branched polypropylene by using LAOS is a convenient and well-established method (see Kamkar, M., et al., “Large amplitude oscillatory shear flow: Microstructural assessment of polymeric systems.” Progress in Polymer Science, 2022, 132, 101580) and has been widely used in the polymer industry. Thus, our analysis of the generation of long-chain branched polypropylene is based on the LAOS analyses, using the obtained Lissajous-Bowditch curve to confirm the generation of long-chain branched polypropylene. Examples I-a, I-b, I-c, II-a, II-b, II-c, II-d, and II-e were shown in the corresponding FIGS. 12 to 19, respectively.

The analysis results are shown in Tables 1 and 2 below.

### 2. Grafting Amount of Long-Chain Branched Polypropylene

The grafting amount of the long-chain branched polypropylene per mole in each example was calculated based on integrated areas of characteristic peaks in a corresponding nuclear magnetic resonance spectrum of the long-chain branched polypropylene. The grafting amount of the long-chain branched polypropylene per mole in each of Examples I-a, I-b, II-a, and II-b was calculated using the following Equation (1):

$$A = ( B / 6 ) / ( C / 6 ) \qquad ( 1 )$$

where A=grafting amount of long-chain branched polypropylene per mole
   B=sum of integrated area(s) of characteristic peak(s) of hydrogens on methyl groups on silicons of T-reagent bound to long-chain branched polypropylene
   C=sum of integrated area(s) of characteristic peak(s) of hydrogens on main chains of long-chain branched polypropylene

The grafting amount of the long-chain branched polypropylene per mole in each of Example I-c, II-c, and II-d was calculated using the following Equation (2):

$$D = ( E / 4 ) / ( F / 6 ) \qquad ( 2 )$$

where D=grafting amount of long-chain branched polypropylene per mole
   E=sum of integrated area(s) of characteristic peak(s) of hydrogens on benzene rings on silicons of T-reagent bound to long-chain branched polypropylene
   F=sum of integrated area(s) of characteristic peak(s) of hydrogens on main chains of long-chain branched polypropylene

The results are shown in Tables 1 and 2 below.

### 3. Amount of Long-Chain Branches

The amount of long-chain branches on the long-chain branched polypropylene per mole in each example was calculated based on integrated areas of characteristic peaks in a corresponding nuclear magnetic resonance spectrum of the long-chain branched polypropylene. The amount of long-chain branches on the long-chain branched polypropylene per mole in each of Examples I-a, I-b, II-a and II-b was calculated using the following Equation (3):

$$G = [ ( H / 6 ) - ( I / 2 ) ] / ( J / 6 ) \qquad ( 3 )$$

where G=amount of long-chain branches on long-chain branched polypropylene per mole
   H=sum of integrated area(s) of characteristic peak(s) of hydrogens on methyl groups on silicons of T-reagent bound to long-chain branched polypropylene
   I=sum of integrated area(s) of characteristic peak(s) of hydrogens of “CH₂” of CH₂═CH— groups of T-reagent bound to long-chain branched polypropylene
   J=sum of integrated area(s) of characteristic peak(s) of hydrogens on main chains of long-chain branched polypropylene

The amount of long-chain branches on the long-chain branched polypropylene per mole in each of Example I-c, II-c, and II-d was calculated using the following Equation (4):

$$K = [ ( L / 4 ) - ( M / 2 ) ] / ( N / 6 ) \qquad ( 4 )$$

where K=amount of long-chain branches on long-chain branched polypropylene per mole
   L=sum of integrated area(s) of characteristic peak(s) of hydrogens on benzene rings on silicons of T-reagent bound to long-chain branched polypropylene
   M=sum of integrated area(s) of characteristic peak(s) of hydrogens of “CH₂” of CH₂═CH— groups of T-reagent bound to long-chain branched polypropylene
   N=sum of integrated area(s) of characteristic peak(s) of hydrogens on main chains of long-chain branched polypropylene

The results are shown in Tables 1 and 2 below.

### Results

Referring to FIGS. 12 to 19, it can be seen that a respective one of the Lissajous-Bowditch curve of the long-chain branched polypropylene of Examples I-a, I-b, I-c, II-a, II-b, II-c, II-d, and II-e is in an elliptical-like shape and has no sharp intersection points at two ends of a major axis of the elliptical-like shape, indicating that the long-chain branched polypropylene in each of Example I-a, I-b, I-c, II-a, II-b, II-c, II-d, and II-e prepared by the method according to the disclosure indeed has a long-chain branched structure as desired.

TABLE 1

| | | Examples | | |
|---|---|---|---|---|
| | | I-a | I-b | I-c |
| Catalytic activity (kg PP/(g catalyst × hr)) | | 13.6 | 18.9 | 15.02 |
| Long-chain | Grafting amount of long- | 4.398 | 13.11 | 4.798 |
| branched | chain branched | | | |
| polypropylene | polypropylene per mole | | | |
| | (×10⁻³) | | | |
| | Amount of long-chain | 1.363 | 0.92 | 1.055 |
| | branches on long-chain | | | |
| | branched polypropylene | | | |
| | per mole (×10⁻³) | | | |
| | Long-chain branched | ◯^{a} | ◯ | ◯ |
| | structure | | | |
| | Cross-linking structure | X^{b} | X | X |

^{a}having a long-chain branched structure
^{b}no cross-linking structure detected

TABLE 2

| | | Examples | | | |
|---|---|---|---|---|---|
| | | II-a | II-b | II-c | II-d |
| Catalytic activity (kg PP/(g catalyst × hr)) | | 1.1 | 0.4 | 0.94 | 0.59 |
| Long-chain | Grafting amount of long- | 2.303 | 2.375 | 4.986 | 8.244 |
| branched | chain branched | | | | |
| polypropylene | polypropylene per mole | | | | |
| | (×10⁻³) | | | | |
| | Amount of long-chain | 0.852 | 0.238 | 1.097 | 1.649 |
| | branches on long-chain | | | | |
| | branched polypropylene | | | | |
| | per mole (×10⁻³) | | | | |
| | Long-chain branched | ◯^{a} | ◯ | ◯ | ◯ |
| | structure | | | | |
| | Cross-linking structure | X^{b} | X | X | X |

^{a}having a long-chain branched structure
^{b}no cross-linking structure detected

In summary, with the introduction of the new T-reagent and the catalyst, the method for preparing the long-chain branched polypropylene according to the disclosure has an advantage that such long-chain branched polypropylene can be obtained via a one-pot and one-step reaction.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for preparing a long-chain branched polypropylene, comprising:
subjecting a T-reagent to a polymerization reaction with propylene in the presence of a catalyst composition;
wherein the catalyst composition includes an alkylaluminoxane and a metallocene-based catalyst, the metallocene-based catalyst containing a metal selected from the group consisting of titanium (Ti), zirconium (Zr), and hafnium (Hf), and the T-reagent having an alkenyl silyl functional group is selected from the group consisting of 1,2-bis[dimethyl(vinyl)silyl]ethane, dimethyldivinylsilane, 7-octenyldimethyl(vinyl)silane, 7-octenyldimethyl(allyl)silane, 4-(but-3-enyl)phenyldimethyl(vinyl)silane, 4-(but-3-enyl)phenyldimethyl(allyl)silane, and combinations thereof.

2. The method as claimed in claim 1, wherein the alkylaluminoxane is methylaluminoxane.

3. The method as claimed in claim 1, wherein the metallocene-based catalyst is selected from the group consisting of a titanium metallocene-based catalyst, a zirconium metallocene-based catalyst, and a hafnium metallocene-based catalyst.

4. The method as claimed in claim 3, wherein the zirconium metallocene-based catalyst is selected from the group consisting of bis-(n-butylcyclopentadienyl)zirconium dichloride ((ⁿBuCp)₂ZrCl₂), bis(n-propylcyclopentadienyl)zirconium dichloride, bis(ethylcyclopentadienyl)zirconium dichloride, bis(methylcyclopentadienyl)zirconium dichloride, bis(1,3-dimethylcyclopentadienyl)zirconium dichloride, bis(1-butyl-3-methylcyclopentadienyl)zirconium dichloride, ethylenebis(indenyl)zirconium dichloride (C₂H₄(Ind)₂ZrCl₂), dimethylsilylbis(2-methylindenyl)zirconium dichloride, dimethylsilylene-bis-(2-methyl-4-phenylindenyl)zirconium dichloride, and dimethylsilylene(bis-indenyl)zirconium dichloride.

5. The method as claimed in claim 3, wherein the hafnium metallocene-based catalyst is selected from the group consisting of bis(cyclopentadienyl) hafnium dichloride, bis(ethylcyclopentadienyl) hafnium dichloride, and bis(isopropylcyclopentadienyl) hafnium dichloride.

6. The method as claimed in claim 4, wherein the zirconium metallocene-based catalyst is dimethylsilylene-bis-(2-methyl-4-phenylindenyl)zirconium dichloride or dimethylsilylene(bis-indenyl)zirconium dichloride.

7. The method as claimed in claim 1, wherein the catalyst composition further includes silica particles, the alkylaluminoxane and the metallocene-based catalyst being carried by the silica particles.

8. The method as claimed in claim 1, wherein the polymerization reaction is a slurry polymerization reaction which is carried out in the presence of the catalyst composition and a solvent for dissolving the propylene.

9. The method as claimed in claim 1, wherein the T-reagent is present in an amount ranging from 1 millimole to 2.5 millimoles.

10. The method as claimed in claim 6, wherein the zirconium metallocene-based catalyst is dimethylsilylene-bis-(2-methyl-4-phenylindenyl)zirconium dichloride, and the T-reagent is selected from the group consisting of 7-octenyldimethyl(vinyl)silane, 7-octenyldimethyl(allyl)silane, 4-(but-3-enyl)phenyldimethyl(vinyl)silane, and 4-(but-3-enyl)phenyldimethyl(allyl)silane.

11. The method as claimed in claim 6, wherein the zirconium metallocene-based catalyst is dimethylsilylene(bis-indenyl)zirconium dichloride, and the T-reagent is 4-(but-3-enyl)phenyldimethyl(allyl)silane.
